(19) United States
(12) Patent Application Publication
(10) Pub. No.: US 2007/0007876 A1
(43) Pub. Date: Jan. 11, 2007

(54) Composition of phosphor layer, display device comprising the same, and manufacturing method thereof

(76) Inventors: Jae-Bin Chung, Suwon-si (KR); Sung-Wan Cho, Suwon-si (KR); Young-Gun Kwon, Suwon-si (KR); Jae-Huy Park, Suwon-si (KR); Chong-In Chung, Suwon-si (KR); Jae-Hong Lim, Suwon-si (KR)

Correspondence Address: Robert E. Bushnell, Suite 300, 1522 K Street, N.W., Washington, DC, 20005, US

(21) Appl. No.: 11/477,913

(22) Filed: Jun. 30, 2006

(30) Foreign Application Priority Data
Jul. 6, 2005 (KR) 10-2005-0060705

(51) Int. Cl. H01J 1/62

(52) U.S. Cl. 313/486; 430/139; 250/483.1; 313/483

(57) ABSTRACT

A composition for forming a phosphor layer includes a phosphor, a binder resin, and an oxidation catalyst. The composition for forming a phosphor layer allows the lowering of a firing temperature of the phosphor layer by the catalyst activity of the oxidation catalyst and preventing deterioration of the phosphor layer or phosphor, and effectively improves the life-span and the brightness of the display device by decreasing the amount of remaining organic material.

### CLAIM OF PRIORITY

This application makes reference to, incorporates the same herein, and claims all benefits accruing under 35 U.S.C. §119 from an application earlier filed in the Korean Intellectual Property Office on 6 Jul. 2005 and there duly assigned Serial No. 10-2005-0060705.

### FIELD OF THE INVENTION

The present invention relates a composition for forming a phosphor layer, a display device including the same, and a method of preparing the same, and more particularly to a composition of a phosphor layer including a phosphor and a binder resin and further including an oxidation catalyst, and a display device including the composition, and a method of preparing the same.

### BACKGROUND OF THE INVENTION

A display device such as a cathode ray tube and a plasma display includes at least one phosphor layer expressing each color of red, green, and blue. The phosphor layer may be provided by a thick membrane method of a wet film process such as screen printing, photosensitive pasting, and photosensitive printing; and a thin membrane method of a dry film process such as sputtering and ion plating.

The wet film process for the phosphor layer includes steps of providing a slurry composition including a suitable phosphor, forming a pattern thereon, and firing the patterned phosphor at a high temperature. After subjecting it to the firing step, ideally all organic material is removed from the phosphor layer and only phosphor remains, but an organic material such as a binder resin for forming the phosphor layer may remain.

Such remaining organic material generates a black spot which is not illuminated when the phosphor layer emits the light by discharging the plasma, which deteriorates the photoluminescence brightness and the brightness maintenance ratio of the phosphor layer. Further, the electric field photoluminescence display generates methane, carbon monoxide, or several organic materials when under a vacuum due to the electron ray impact or other light, or thermochemical effects occur upon irradiating the electron rays. Such organic materials contaminate the electron ray emission source so that the electron ray emission is decreased and an electrical arc occurs by the vacuum discharge. Accordingly, the properties of the display device including the phosphor layer are deteriorated due to the remaining organic material and the life-span is shortened after subjecting it to the firing process.

The firing process is carried out at 450° C. or more in order to pyrolyze the organic component such as a binder resin in a composition for forming a phosphor layer. However, polyvinylalcohol (PVA) commonly used for a photosensitive binder resin begins to be pyrolyzed at 250° C. but is not completely decomposed at 450° C. In addition, since the composition for forming the phosphor layer includes an additive such as a cross-linking agent, a photoinitiator, a surfactant, a photosensitive agent, a polymerization inhibitor, an antifoaming agent, a leveling agent, and a plasticizer in addition to the organic binder, the firing temperature should be increased to completely remove these organic components.

When it is fired at a high temperature of 500° C. or more, the phosphor is deteriorated so that the brightness and the life-span of the display device decrease. Accordingly, it is preferably fired at as low a temperature as possible to prevent deteriorating the phosphor.

Korean patent laid-open publication No. 10-2001-109538 discloses a method including the steps of mixing an agent for improving the pyrolysis of the binder resin such as ammonium peroxy disulfate, ammonium perchlorate, and ammonium oxalate in the composition for forming the phosphor layer and firing it at 400° C. However, it was not impossible to obtain a clear phosphor layer pattern when the present inventor attempted to prepare it in accordance with the above-mentioned method.

Korean patent laid-open publication No. 10-2000-67004 discloses a binder resin of a composition for forming a phosphor layer including reactive cellulose derivates having double bonds. It is fired at 410° C. without an additional crosslinking agent and crosslinking monomer, and the amount of the remaining organic material is less than 5% upon firing it at 600° C.

### SUMMARY OF THE INVENTION

An exemplary embodiment of the present invention provides a composition for forming a phosphor layer, a panel display including the same, and a method of preparing the same. Another embodiment of the present invention provides a composition for forming a phosphor layer that is capable of decreasing the firing temperature when preparing a phosphor layer and effectively pyrolyzing the remaining organic material which produces the exhaust gas.

Yet another embodiment of the present invention provides a display device including a phosphor layer composed of the composition for forming the phosphor layer.

According to an embodiment of the present invention, a composition for forming a phosphor layer includes a phosphor, a binder resin, and an oxidation catalyst.

The oxidation catalyst may be included at preferably 0.1 to 10.0 wt %, more preferably 0.1 to 20.0 wt % based on the total weight of the binder resin and the oxidation catalyst.

Further, the present invention provides a phosphor layer prepared from the composition for forming the phosphor layer and a method of preparing the same.

The phosphor layer may include remaining organic material at less than 240 ppm, and it is prepared by subjecting it to a firing process at 350 to 440° C.

### BRIEF DESCRIPTION OF THE DRAWINGS

A more complete appreciation of the present invention, and many of the above and other features and/or advantages of the present invention, will be readily apparent as the same becomes better understood by reference to the following detailed description when considered in conjunction with the accompanying drawings:

FIG. 1 is a thermogravimetric analysis (TGA) graph showing PVA pyrolysis characteristics depending upon the Fe oxidation catalyst;

FIG. 2 is a TGA graph showing PVA pyrolysis characteristics when using 10 wt % V₂O₅/TiO₂ and Fe₂O₃/TiO₂ as a supported catalyst;

FIG. 3 is a TGA graph showing PVA pyrolysis characteristics when using zeolite as an oxidation catalyst;

FIG. 4 is a TGA graph showing phosphor layer pyrolysis characteristics when using Fe as an oxidation catalyst;

FIG. 5 is a TGA graph showing phosphor layer pyrolysis characteristics when using an oxidation catalyst of CoO, FeO, and TiO₂;

FIG. 6 is a TGA graph showing phosphor layer pyrolysis characteristics depending upon the amount of a TiO₂ oxidation catalyst; and

FIG. 7 is a TGA graph showing phosphor layer pyrolysis characteristics depending upon the amount of a V₂O₅/TiO₂ supported catalyst.

### DETAILED DESCRIPTION OF THE INVENTION

The composition for forming a phosphor layer according to the present invention includes components of at least one of red, green, and blue phosphors, and a binder resin, and further includes an oxidation catalyst. The firing temperature is remarkably lowered by adding an oxidation catalyst thereto upon preparing the phosphor layer, and it pyrolyzes the organic materials in the phosphor layer to decrease the remaining organic materials in the phosphor layer to less than 220 ppm. Thereby, it is possible to improve the brightness and the life-span of the obtained display device.

The oxidation catalyst increases the decomposition rate and the decomposition ratio of the organic compound such as a binder resin upon preparing the phosphor layer, and allows the oxidation reaction to be carried out at a low temperature. The amount of the oxidation catalyst used is preferably 0.1 to 20.0 wt %, more preferably 0.1 to 10.0 wt % based on the total weight of the binder resin and the oxidation catalyst. If the amount of the oxidation catalyst is less than the range, an improvement in the decomposition efficiency of the organic compound may not occur, and when it is more than the range, problems such as deterioration of surface characteristics of the phosphor provided layer may occur and the brightness is decreased.

Particularly, the oxidation catalyst may be an active metal or oxide thereof, a supported catalyst having a catalyst component supported on a carrier or support, or a zeolite oxidation catalyst. In addition, the active metal maximizes the function of the active metal by further adding a co-catalyst including additional active metal as required. The co-catalyst includes at least one metal selected from the group consisting of active metals excepting the main active metal.

The active metal includes at least one transition element selected from the group consisting of Ti, Fe, Cr, Ni, Co, V, W, Mo, Mn, and Sn and/or at least one noble metal selected from the group consisting of Pt, Rh, and Pd.

An active metal oxide may include the transition elements or a noble metal oxide, the non-limiting examples thereof include one component systems such as TiO₂, Fe₂O₃, Cr₂O₃, NiO, CO₂O₃, V₂O₅, WO₃, MoO₃, MnO₂, or SnO₂, two component systems such as CuO—TiO₂, CuO—Al₂O₃, Fe₂O₃—TiO₂, WO₃—TiO₂, or V₂O₅—Al₂O₃, and three component systems such as V₂O₅—SiO₂—TiO₂.

The active metal oxide oxidation catalyst may include one having a particle diameter of 50 nm to 1 μm, preferably 120 nm to 250 nm considering productivity of the preparation of the phosphor layer and physical properties of the phosphor layer provided. In the case that the particle diameter is less than the range, it is hard to control the particle size, and the ball mill process takes an excessive amount of time. In addition, coagulation between particles may occur. On the other hand, when the particle diameter is above the range, the surface properties of the phosphor layer may be deteriorated.

The active metal or the oxide thereof may be a supported catalyst. The carrier may be any one commonly available in the market, and it preferably has microporosity. It has a specific surface area of 70 m²/g to 240 m²/g and a particle diameter of 50 nm to 500 nm, preferably 70 nm to 160 nm for sufficiently supporting the active metal or the oxide thereof.

Further, the supported catalyst may include any one supporting the active metal or the oxide thereof in the amount of 1.0 to 20 wt % based on the total weight of the active metal or the oxide thereof and the support. In the case that the supporting amount of the active metal or the oxide thereof is less than the range, the synergy effect between synthetic metals is insufficient, and if it is more than the range, the catalyst may be coagulated and the particle size may be overly large.

Non-limiting examples of the carrier for the supported catalyst include at least one selected from the group consisting of Al₂O₃, TiO₂, MnO, zeolite, carbon black, ketjen black, acetylene black, activated carbon powder, fullerene (C60), carbon nanotubes, carbon nanofiber, carbon nanowire, carbon nanohorns, and carbon nanorings. They may be pellet, ceramic honeycomb, or metal wire shaped, but they are not limited thereto.

The zeolite may be the oxidation catalyst by itself, or it may be a carrier for the supported catalyst to improve surface activity since it has a high specific surface area.

Suitable zeolite may be natural or synthesized zeolite, but it is not limited thereto. According to one embodiment, it may be clinoptilolite, chabazite, erionite), philipsite, ZSM-5, mordenite, ferrierite, A-type zeolite, X-type zeolite, and Y-type zeolite, and so on, which are well known as carriers of a catalyst.

As mentioned above, the active metal or the oxide thereof, the supported catalyst, and the zeolite oxidation catalyst may be directly prepared in accordance with known processes or they may be any commercially available in the market. The oxidation catalyst may be chosen by one having ordinary skill in the art considering catalyst activity of a catalyst composition, particle size, surface area, pore structure, crystallinity, and metal phase, and the kind of organic composition for forming the phosphor layer.

The composition for forming the phosphor layer including the above mentioned oxidation catalyst includes a phosphor, a binder resin, and a solvent, and it further includes several additives. The amount of each is determined to be appropriate for the oxidation catalyst.

The phosphor is any one commonly used in the display device field, and is not limited in the present invention. Representative display devices may include a plasma display panel (PDP), a cathode ray tube (CRT), a field emission display (FED), and an organo-electroluminescent Display (ELD).

The binder resin may include a polymer that is capable of easy removal during the developing process upon forming the phosphor layer, and any material commonly used in this field of the present invention. Non-limiting examples of the binder resin include a homopolymer such as polyvinyl alcohol, polyacryl amide, poly(metha)acrylate, polystyrene, polyacrylic acid ester, polyvinylbutyral, a cellulose, a novolac resin, copolymers thereof, and combinations thereof. The number average molecular weight (Mn) of the binder resin should be between 5000 and 50,000 considering decomposition during the developing process.

Non-limiting examples of the solvent include water, a ketone, an alcohol, an ether-based alcohol, a saturated aliphatic monocarboxylic acid alkyl ester, a lactic acid ester, and an ether-based ester. The examples of ketone include diethyl ketone, methyl butyl ketone, dipropyl ketone, cyclohexanone, and so on. The examples of alcohol include n-pentenol, 4-methyl-2-pentenol, cyclohexanol, diacetone alcohol, and so on. The examples of ether-based alcohol include ethylene glycol monomethylether, ethylene glycol monoethylether, ethylene glycol monobutylether, propylene glycol monomethyl ether, propylene glycol monoethylether, and so on. The examples of saturated aliphatic monocarboxylic acid alkyl ester include n-butyl acetate, amyl acetate, and so on. The examples of lactic acid ester include ethyl lactate, n-butyl lactate, and so on. The examples of ether-based ester include methylcellosolve acetate, ethylcellosolve acetate, propylene glycol monomethylether acetate, ethyl-3-ethoxypropinonate, and so on. The above solvents can be used singularly or in combination.

The additive may include a dispersing agent for improving dispersion, a cross-linking agent, a sensitizer for improving sensitivity, a polymerization inhibitor and an antioxidant for improving the conservation of the coating composition, an ultraviolet ray absorber for improving the resolution, an antifoaming agent for decreasing foaming in a slurry composition, a leveling agent for improving the level of the membrane in the printing process, a plasticizer for providing flexibility, and a pH controlling agent, and it further includes a photosensitivity agent and a photoinitiator in the photosensitive paste process and photosensitive printing process.

The method of preparing a composition for forming a phosphor layer including the above-mentioned composition includes mixing and dissolving a phosphor, a binder resin, an oxidation catalyst, and other additives in a solvent to provide a paste composition. The mixing process may be carried out with a roll mixer, a mixer, a homomixer, a ball mill, or a bead mill. In addition, the oxidation catalyst may be pulverized into particles having suitable size.

The composition for forming a thick phosphor layer according to the present invention is prepared as a phosphor layer in accordance with the wet film process mentioned above. The wet film process is not limited in the present invention, and it may include any one conceivable to one having ordinary skill in the art, such as screen printing, photosensitive pasting, photosensitive printing, and a dry film process.

The wet method of preparing the phosphor layer includes printing or coating the composition for forming the phosphor layer according to the present invention on a substrate, drying the coated composition, forming a pattern on the phosphor layer, and firing the patterned phosphor to form a patterned phosphor layer.

Particularly, the present invention is able to lower the firing temperature of the firing process from the range of 450° C. or more to the range of 400° C. or less upon preparing the phosphor layer by adding an oxidation catalyst to the composition for forming the phosphor layer. That is, it promotes decomposition of the organic material such as the binder resin in the firing process by adding the oxidation catalyst so that the pyrolysis temperature is lowered and the pyrolysis rate is promoted. Thereby, it is possible to completely remove the organic compound even if the firing process is carried out at a lower temperature. In this case, it is carried out at a firing temperature of 350 to 440° C. for 0.5 to 3 hours. If the firing temperature is too low or the firing duration is too short, it is hard to remove the binder polymer from the patterned phosphor layer, but if the firing temperature is too high or the firing duration is too long, deterioration of the phosphor may occur.

Although the firing process of the provided phosphor layer may be carried out at a lower temperature of 440° C., the amount of remaining organic material is less than 220 ppm such that the phosphor layer can be applied to all kinds of display devices including a phosphor layer.

Such a display device is preferably a plasma display device, a cathode ray tube, a field emission display device, or an organic field emission display device. As a result of the present invention, the firing temperature is decreased when preparing the phosphor layer to prevent deterioration of the phosphor layer (or phosphor). Further, it decreases the amount of remaining organic material to remarkably improve the life-span and brightness of the display device.

The following examples illustrate the present invention in more detail. However, it is understood that the present invention is not limited by these examples.

### EXAMPLE

### Preparation Example 1

### Catalyst

A: Active Metal Oxidation Catalyst

Iron nitrate (III) (Fe(NO₃)₃.H₂O) was dispersed into pure water at a concentration of 5%, to provide a Fe³⁺ metal oxidation catalyst dispersed as an aqueous solution.

Using the same process, Fe³⁺ and V⁵⁺ active metal oxidation catalysts were provided by using iron chloride (FeCl₃) and ammonium meta-vahadate (NH₄VO₃).

B: Active Metal Oxide Oxidation Catalyst

CoO powder was pulverized and dispersed into pure water to provide a Fe₂O₃ oxidation catalyst, and a TiO₂ oxidation catalyst was provided using the same process.

C: Active Metal Oxide Supported Catalyst

The metal ion aqueous solution prepared from the step A was mixed with a TiO₂ carrier (specific surface area, >150 m²/g) dispersed in pure water, dehydrated, and dried at 105° C. Then, it was fired at 550° C. to provide a supported catalyst such that Fe₂O₃ was supported on the TiO₂ carrier. The amounts of metal oxide were respectively controlled to 5% and 10% by adjusting the adding amounts of the metal ion aqueous solution and the carrier.

A V₂O₅/TiO₂ supported catalyst was prepared by using an aqueous solution containing vanadium from the step A using the same process.

### Experimental Example 1

### Pyrolysis Characteristic Test Depending Upon the Catalyst

To analyze the promoting activity when pyrolyzing the oxidation catalyst depending upon the organic compound, 9.2 kg of polyvinyl alcohol (PVA) having a number average molecular weight of 1800 was dispersed in 210 L of water, and 0.5 kg of an oxidation catalyst was mixed therein, and thermogravimetric analysis (TGA) was carried out.

TGA is an analysis technique used to obtain a qualitative and quantitative analyses of the thermal changes from the obtained curve of shifting temperature and weight. From the curve, the thermal stability of the sample, the composition ratio, and the amount of the organic material remaining after heating is obtained. TGA analysis was performed by increasing the temperature by 10° C. per minute under a flowing air purge atmosphere of 100 cc/min, and the relative weight ratio against PVA was calculated.

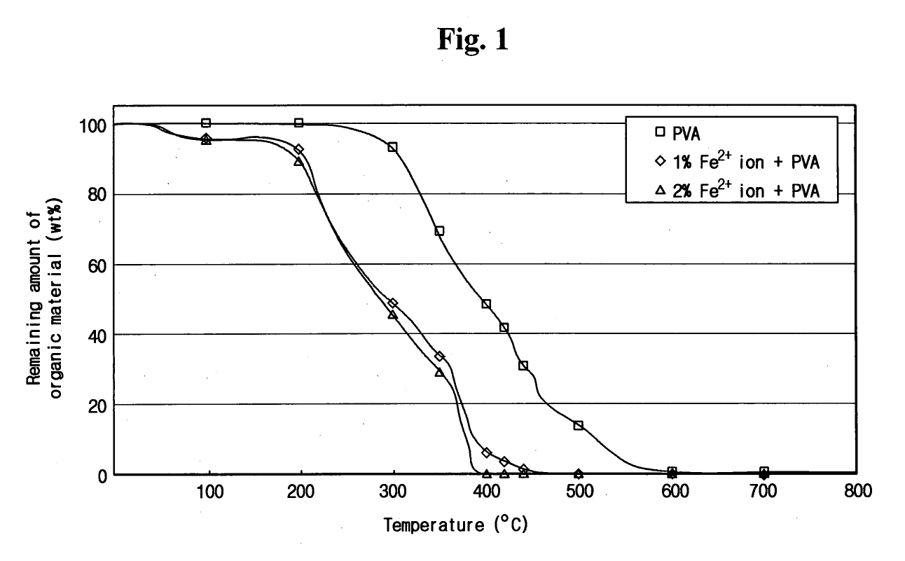

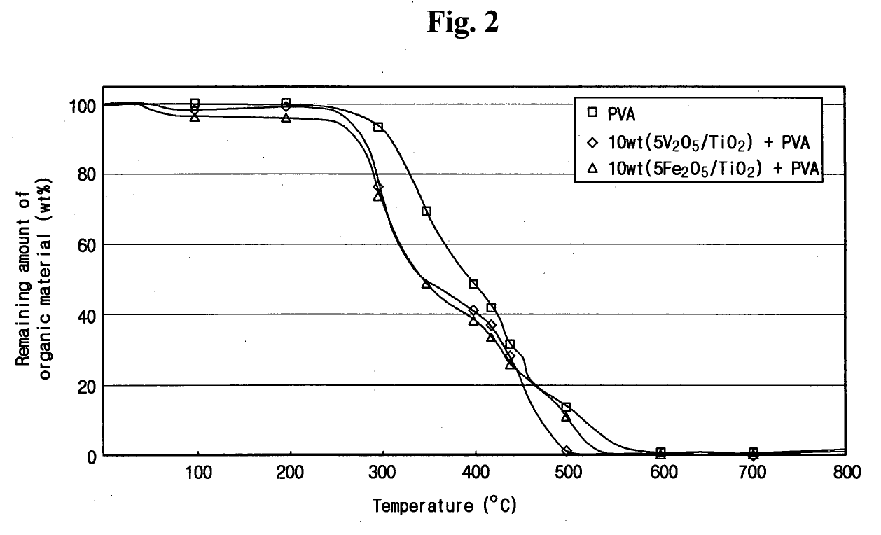

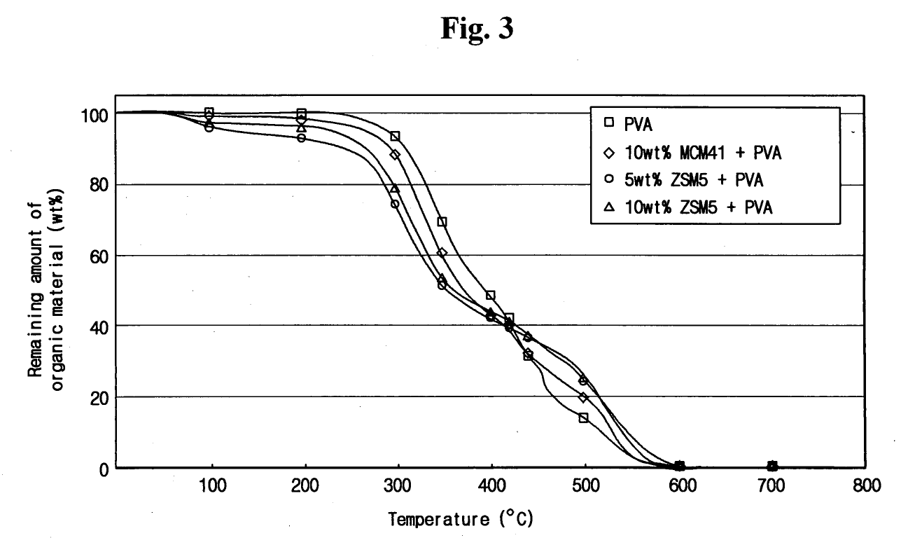

FIG. 1 is a TGA graph showing the case in which an Fe oxidation catalyst was used at 1.0 wt % and 2.0 wt %, FIG. 2 is a TGA graph showing the case in which 5% of a V₂O₅/TiO₂ supported catalyst and 5% of an Fe₂O₃/TiO₂ supported catalyst were used at 10 wt %, and FIG. 3 is a TGA graph showing that zeolite (ZSM5) was used at 5 and 10 wt % and zeolite (MCM-41) at 10 wt %.

As shown in FIG. 1 to FIG. 3, the oxidation of PVA began at around 300° C. and finished at 550° C., and the decomposition rate was increased by using the oxidation catalyst according to the present invention. It shows that using the supported catalyst resulted in temperature-lowering effects of about 50° C. or more. In the case of an Fe oxidation catalyst, the oxidation began at around 200° C., and the decomposition rate was 85.3% at 380° C. (FIG. 1).

From the result, it was found that the oxidation catalyst effectively promoted decomposition of the organic compound such as the organic.

### Example 1

### Preparation of Composition for Forming Phosphor Layer, and Phosphor Layer

The following procedure was carried out in order to show the pyrolysis characteristics of the composition for forming the phosphor according to the present invention.

Firstly, a phosphor (30 kg), a polyvinylalcohol binder resin (5%, 44.78 kg), a cross-linking agent (ethylene glycol, 1.12 kg), a photoinitiator (sodium dichromium, 5%, 0.67 kg), N-methyl-2-pyrrolidone (NMP, 50%, 2.44 kg), and pure water (7.19 kg) were injected into a mixer and agitated. The catalyst obtained from Experimental Example 1 was then mixed therein. Agitation and dispersion processes using a 3-roll mill and filtration and defoaming processes were further carried out to provide a slurry composition. The type, the composition, and the amount of catalyst were changed as shown in Table 1.

TABLE 1

| Catalyst type | | Amount |
|---|---|---|
| Active metal oxidation catalyst | Fe³⁺ | 0.5 wt % |
| | | 1.0 wt % |
| Active metal oxide catalyst | CoO | 1.0 wt % |
| | Fe₂O₃ | 0.5 wt % |
| | TiO₂ | 1.0 wt % |
| | | 5.0 wt % |
| | | 10 wt % |
| | | 20 wt % |
| Supported catalyst | 10% V₂O₅/TiO₂ | 1.0 wt % |
| | | 10 wt % |
| | | 20 wt % |

* total amount of oxidation catalyst and PVC binder resin: satisfying 100 wt %.

The provided slurry composition was printing-coated on a glass substrate to a thickness of 0.1 mm by a screen printer, and dried at 100° C. for 10 minutes to provide a coating membrane in a thickness of 5 μm. Thereafter, a photomask patterned with predetermined stripes spaced apart from each other was disposed thereon, it was exposed at 450 mJ/cm² using an exposure device to allow crosslinking, and it was developed for 25 seconds using a nozzle outputting a 0.4 wt % sodium carbonate aqueous solution with a spray pressure of 1.2 kgf/cm². Thereby, the non-exposed region was removed, and it was then fired at 440° C. for 35 minutes to provide a patterned phosphor layer having a membrane thickness of 4 μm.

### Comparative Example 1

A slurry composition was prepared in the same manner as in Example 1, except that the oxidation catalyst was not used, and a phosphor layer was prepared from the same.

### Experimental Example 2

### Pyrolysis Characteristic Depending Upon Active Metal Oxidation Catalyst

In the case of using an Fe³⁺ oxidation catalyst, TGA analysis was carried out in order to determine the remaining amount of organic compound in the phosphor layer.

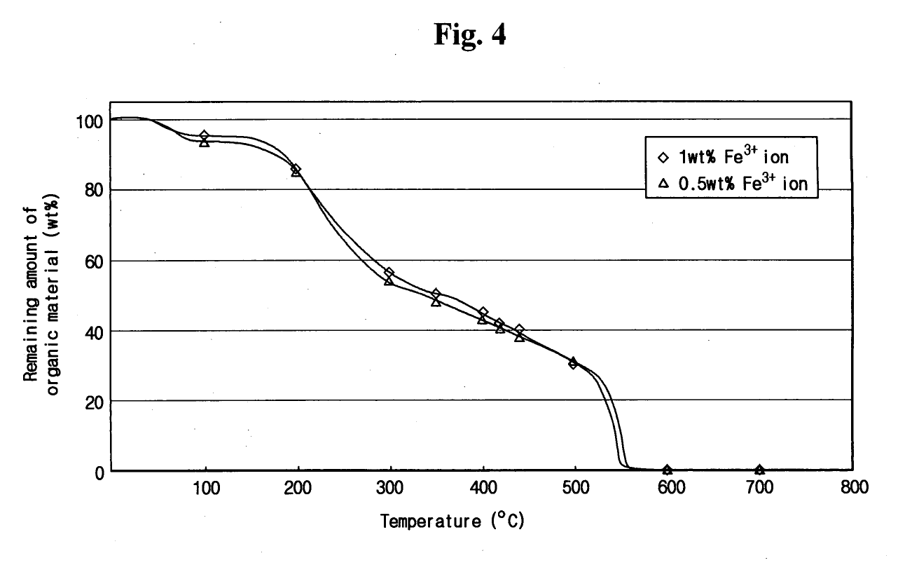

As shown in FIG. 4, the decomposition rate of the organic material was increased in the phosphor layer by using the active metal oxidation catalyst so that the amount of remaining organic material can be reduced. From the results, it is shown that the pyrolysis is promoted when increasing the amount of the active metal. The carbon amount remaining in the phosphor layer after firing was measured using C/S ultra-red ray analysis and the result showed that the remained carbon amount was 218 ppm after firing at 440° C.

### Experimental Example 3

### Pyrolysis Characteristic Depending Upon the Type of Active Metal Oxide Oxidation Catalyst

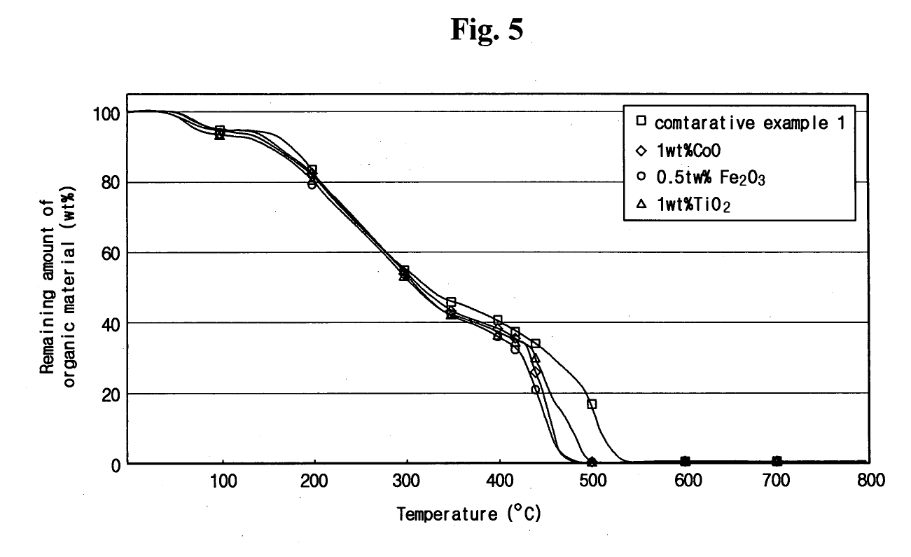

The active metal oxides of CoO, Fe₂0₃, and TiO₂ were used for the oxidation catalyst, and the TGA graph of FIG. 5 was obtained when using the same procedure as in Example 2. As shown in FIG. 5, it was found that all the active metal oxides promoted the pyrolysis of the organic compound by the oxidation catalyst. The remaining amount of the carbon was 221 ppm after the firing process.

### Experimental Example 4

### Pyrolysis Characteristic Depending Upon the Amount of Active Metal Oxide

TiO₂ active metal oxide was used for the oxidation catalyst, and amounts used thereof were 1, 5, 10, and 20 wt % to obtain a TGA graph.

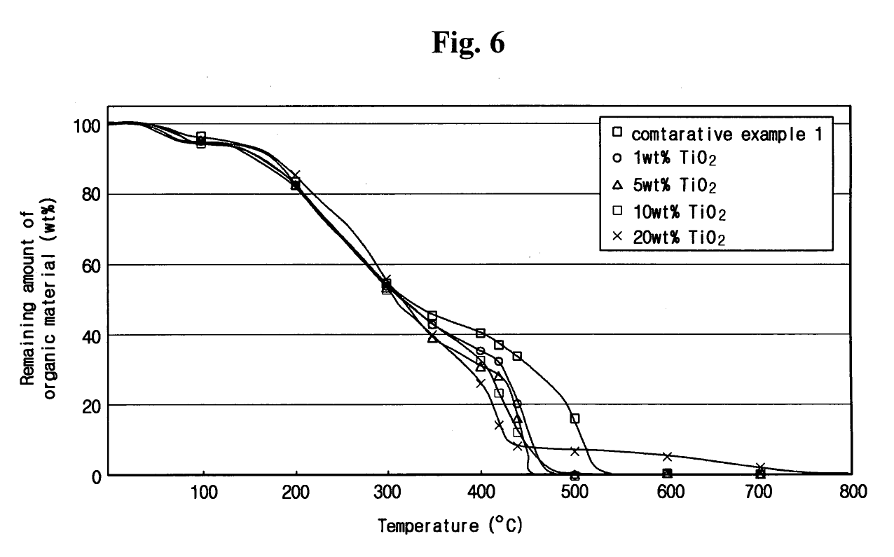

Referring to FIG. 6, the TiO₂ oxidation catalyst had a superior promoting activity on pyrolyzing the organic compound to that of Comparative Example 1, but the results were insignificantly different depending upon the amounts of the catalyst. However, in the case of using 20 wt %, it was found that the decomposition rate was remarkably decreased at about 400° C. or more and it was almost completed around 750° C. or more. The results show that when the phosphor layer was fired at 440° C., the remained carbon amount was 223 ppm.

### Experimental Example 5

### Pyrolysis Characteristics Depending Upon Amount of Supported Catalyst

V₂O₅/TiO₂ was used for a supported catalyst, and the amounts used thereof were 1, 10, and 20 wt % to obtain a TGA graph.

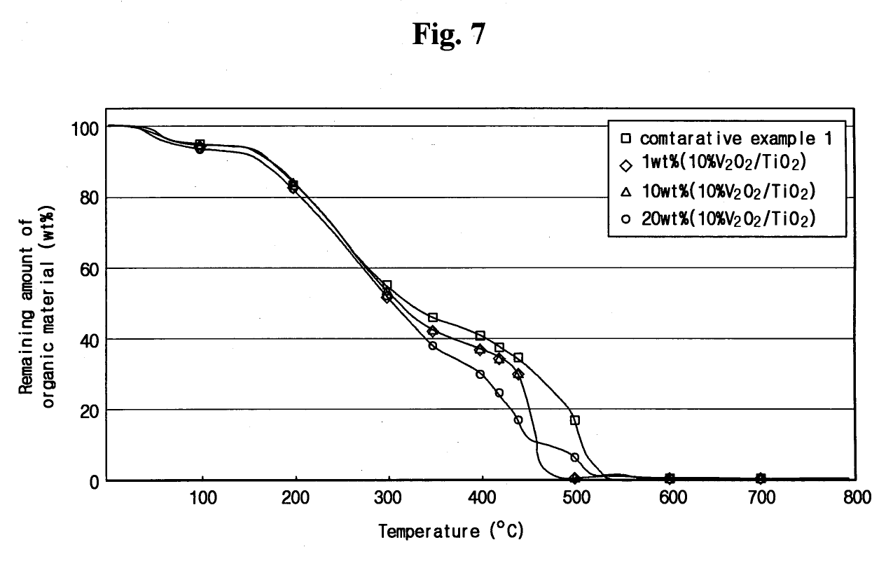

Referring to FIG. 7, the case of using the oxidation catalyst as in Experimental Example 4 showed superior promotion activity on pyrolyzing the organic compound compared to that of Comparative Example 1. Even though the results were not remarkably different depending upon changing the amounts, it showed the best activity in the case of the amount of 1 to 10 wt %. In the case of using 20 wt %, the decomposition rate of the organic compound was remarkably decreased at 440° C. or more, and the decomposition was almost completed at 600° C. or more. The results show that when a phosphor layer added with 5% TiO₂ was fired at 440° C., the remaining carbon amount was 220 ppm.

From the results of Experimental Examples 2 to 5, since the phosphor layer of the present invention was prepared by using the oxidation catalyst, the pyrolysis of the organic compound was promoted to increase the pyrolysis efficiency by 5 to 10% at 400° C. The results show that the firing temperature is lowered by using a small amount of oxidation catalyst when preparing a composition for forming a phosphor layer.

### Experimental Example 6

### Brightness Characteristic of Phosphor Layer Depending Upon Oxidation Catalyst

The follows process was carried out in order to verify that the phosphor layer prepared from the composition for forming the phosphor layer according to the present invention minimized the amount of the remaining organic material and increased the brightness of the display device.

A composition for forming a phosphor layer was obtained by using a TiO₂ metal oxide oxidation catalyst as an oxidation catalyst and V₂O₅/TiO₂ as a supported catalyst, and changing their amounts while using the same procedures. Thereafter, it was spin coated on a 2×2 cm glass substrate with a phosphor combination solution, and fired to provide a phosphor layer. Then, the obtained phosphor layer was measured for brightness using the powder brightness device and the results are shown in the following Table 2.

TABLE 2

| | Control | TiO₂ | | V₂O₅/TiO₂ | |
|---|---|---|---|---|---|
| Amount | — | 10 wt % | 20 wt % | 10 wt % | 20 wt % |
| CIE x | 0.297 | 0.296 | 0.296 | 0.292 | 0.292 |
| CIE y | 0.617 | 0.617 | 0.617 | 0.617 | 0.616 |
| Brightness | 100% | 101% | 95% | 85% | 93% |
| ratio | | | | | |
| Firing | 440° C. | 400 ° C. | 400° C. | 400° C. | 440° C. |
| temperature | | | | | |

* Total amount of oxidation catalyst and PVC binder resin: satisfying 100 wt %.

Referring Table 2, it is found that the CIE color coordinate level of the case of not using the oxidation catalyst is similar to that of using the oxidation catalyst. Further, in the case of using the oxidation catalyst, the brightness is slightly decreased but the decrease is not significant.

Accordingly, a composition for forming a phosphor layer containing an oxidation catalyst according to the present invention and a phosphor layer is provided. The composition for forming a phosphor layer allows the lowering of a firing temperature of the phosphor layer by the catalyst activity of the oxidation catalyst and preventing deterioration of the phosphor layer or phosphor, and effectively improves the life-span and the brightness of the display device by decreasing the amount of remaining organic material.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A composition for forming the phosphor layer, comprising:
a phosphor;
a binder resin; and
an oxidation catalyst.

2. The composition for forming the phosphor layer according to claim 1, wherein the amount of the oxidation catalyst is in a range from 0.1 to 20.0 wt % based on the total weight of the binder resin and the oxidation catalyst.

3. The composition for forming the phosphor layer according to claim 1, wherein the amount of the oxidation catalyst is in a range from 0.1 to 10.0 wt % based on the total weight of the binder resin and the oxidation catalyst.

4. The composition for forming the phosphor layer according to claim 1, wherein the oxidation catalyst is at least one selected from the group consisting of an active metal, an active metal oxide, a supported catalyst having a catalyst component supported on a carrier where the catalyst component is the active metal or the active metal oxide, and a zeolite.

5. The composition for forming the phosphor layer according to claim 4, wherein the oxidation catalyst is at least one selected from the group consisting of Ti, Fe, Cr, Ni, Co, V, W, Mo, Mn, Sn, Pt, Rh, and Pd.

6. The composition for forming the phosphor layer according to claim 4, wherein the active metal oxide includes a transition element or a noble metal oxide.

7. The composition for forming the phosphor layer according to claim 4, wherein the active metal oxide is a one-component system selected from the group consisting of TiO₂, Fe₂O₃, Cr₂O₃, NiO, CO₂O₃, V₂O₅, WO₃, MoO₃, MnO₂, and SnO₂, a two-component system selected from the group consisting of CuO—TiO₂, CuO—Al₂O₃, Fe₂O₃—TiO₂, WO₃—TiO₂, or V₂O₅—Al₂O₃, or a three-component system selected from the group consisting of V₂O₅—SiO₂—TiO₂.

8. The composition for forming the phosphor layer according to claim 4, wherein the supported catalyst comprises the active metal or the active metal oxide supported in the amount of 1.0 to 20 wt % on the carrier based on the total amount of the active metal or the active metal oxide and the carrier.

9. The composition for forming the phosphor layer according to claim 8, wherein the carrier comprises at least one selected from the group consisting of Al₂O₃, TiO₂, MnO, zeolite, carbon black, ketjen black, acetylene black, activated carbon powder, fullerene (C60), carbon nanotubes, carbon nanofiber, carbon nanowire, carbon nanohorns, and carbon nanorings.

10. The composition for forming the phosphor layer according to claim 4, wherein the oxidation catalyst further comprises a co-catalyst.

11. The composition for forming the phosphor layer according to claim 1, wherein the binder resin comprises at least one homopolymer selected from the group consisting of polyvinylalcohol, polyacrylamide, poly(meth)acrylate, polystyrene, polyacrylic acidester, polyvinylbutyral, a cellulose, a novolac resin, copolymers thereof, and blends thereof.

12. The composition for forming the phosphor layer according to claim 1, further comprising at least one additive selected from the group consisting of a dispersing agent, a cross-linking agent, a sensitizer, a polymerization inhibitor, an antioxidant, an ultraviolet ray absorber, an antifoaming agent, a leveling agent, a plasticizer, a pH controlling agent, a photosensitive agent, and a photoinitiator.

13. A method of preparing a phosphor layer, comprising:
printing or coating a substrate with the composition according to claim 1;
drying the composition coated on the substrate;
forming a pattern on the phosphor layer; and
firing the patterned phosphor layer.

14. The method of claim 13, wherein the firing is performed at a temperature ranging from 350 to 440° C.

15. A display device comprising a phosphor layer prepared with the method of claim 13.

16. The display device comprising the phosphor layer according to claim 15, wherein the phosphor layer includes a remaining organic material at less than 220 ppm when at a lower temperature of 440° C.

17. The display device comprising the phosphor layer according to claim 15, wherein the display device is selected from the group consisting of a plasma display device, a cathode ray tube, a field emission display device, and an organic field emission display device.
